(19) United States
(12) Patent Application Publication
(10) Pub. No.: US 2026/0150140 A1
(43) Pub. Date: May 28, 2026

(54) THROUGHPUT BASED SCELL ADDITION OR MEASUREMENT CONFIGURATION

(71) Applicant: RAKUTEN SYMPHONY, INC., Tokyo (JP)

(72) Inventors: Gugan ILANGOVAN, Karnataka (IN); Raghul SUNDARAVARADHAN, Karnataka (IN)

(73) Assignee: RAKUTEN SYMPHONY, INC., Tokyo (JP)

(21) Appl. No.: 19/077,536

(22) Filed: Mar. 12, 2025

(30) Foreign Application Priority Data
Nov. 28, 2024 (IN) 202411093223

(51) Int. Cl. H04W 76/15; H04W 24/02; H04W 52/02; H04W 76/28

(52) U.S. Cl. CPC H04W 76/15; H04W 24/02; H04W 52/0212; H04W 76/28

(57) ABSTRACT

A method includes configuring one or more network parameters at a primary cell. The method includes transmitting a secondary cell addition command to add the one or more secondary cells for the data transmission and/or a secondary cell measurement configuration to a UE 400, for the secondary cell addition, based on the one or more configured network parameters. The method includes performing a secondary cell activation and/or a secondary cell deactivation for the one or more added secondary cells based on a first threshold value. The method includes transmitting, after the secondary cell deactivation, a secondary cell removal command to eliminate the one or more added secondary cells and/or a removal of secondary cell measurement configuration for the secondary cell addition, based on the one or more configured network parameters.

### CROSS REFERENCE TO RELATED APPLICATION(S)

This application claims priority based on India Patent Application No. 202411093223 filed Nov. 28, 2024, the entire disclosure of which is incorporated by reference herein.

### FIELD

The present disclosure relates to a throughput based Secondary Cell (Scell) addition or measurement configuration.

### BACKGROUND

The information disclosed in this background section is only for enhancement of understanding of the general background of the disclosure and should not be taken as an acknowledgement or any form of suggestion that this information forms the prior art already known to a person skilled in the art.

In telecommunication systems, a primary cell, commonly referred to as PCell, comprises a primary communication channel through which User Equipment (UE) establishes and sustains connectivity with a base station (e.g., evolved Node B (eNB), gNB, etc.). The primary cell is an initial cell to which the UE connects during an initialization phase for control signaling and data transfer. Conversely, a secondary cell, commonly referred to as SCell, represents an additional communication channel that can be activated to augment data throughput and enhance the performance of the UE. Secondary cells are particularly significant in scenarios involving a Carrier Aggregation (CA), where multiple frequency bands are leveraged concurrently to expand bandwidth.

In the context of telecommunication systems, CA is enabled within the eNB such as Single Carrier Combined (1CC), Two Carriers Combined (2CC), Three Carriers Combined (3CC), or Four Carriers Combined (4CC), etc., A sequence of operations is initiated upon successful attachment of the UE with the eNB. Following the attachment, when the UE is capable of the CA, the eNB configures the CA measurement parameters specific to the UE. Once these CA measurement parameters are collected, the eNB proceeds to add SCells using existing SCell addition mechanisms.

For instance, the first mechanism is a blind SCell addition, which occurs when a blind SCell list is available. In this first mechanism, the eNB can immediately add the specified SCells after the UE's attachment, without requiring prior measurement data from the UE. During this process, the eNB and UE may engage in multiple operations, as described in conjunction with FIGS. 1A-1B. The second mechanism is a measurement-based SCell addition, which is utilized when the blind SCell list is not present. Here, the addition of SCells depends on measurement reports generated by the UE. The eNB evaluates the quality of the SCells based on this measurement data before proceeding with the addition, and similar to blind SCell addition, multiple operations may be performed by both the eNB and UE, as described in conjunction with FIGS. 2A-2B.

After the SCells have been added, their activation or deactivation is managed by Layer 2(L 2 ), based on a size of a Radio Link Control (RLC) queue, as described in conjunction with FIGS. 1A-1B and FIGS. 2A-2B. This dynamic management is crucial for optimizing data transmission efficiency and effective resource allocation within a network.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to one embodiment of the present disclosure, a method is disclosed. The method includes establishing, by a primary cell of a base station, a connection with a User Equipment (UE) for data transmission. The base station comprises the primary cell and one or more secondary cells. The method further includes configuring, at the primary cell, one or more network parameters. The one or more network parameters comprise a first threshold value (A), a second threshold value (B), and a configurable observation period (T) for the data transmission. The method further includes transmitting, by the primary cell, at least one of a secondary cell addition command to add the one or more secondary cells for the data transmission and a secondary cell measurement configuration to the UE for the secondary cell addition, based on the one or more configured network parameters. The method further includes performing, by the primary cell, at least one of a secondary cell activation and a secondary cell deactivation for the one or more added secondary cells based on the first threshold value (A). The method further includes transmitting, by the primary cell, at least one of a secondary cell removal command to eliminate the one or more added secondary cells and a removal of secondary cell measurement configuration for secondary cell addition, based on the one or more configured network parameters.

According to one embodiment of the present disclosure, an apparatus is disclosed. The apparatus may establish a connection with a User Equipment (UE) for data transmission. A base station associated with the apparatus comprises a primary cell and one or more secondary cells. The apparatus may further configure, at the primary cell, one or more network parameters. The one or more network parameters comprise a first threshold value (A), a second threshold value (B), and a configurable observation period (T) for the data transmission. The apparatus may further transmit at least one of a secondary cell addition command to add the one or more secondary cells for the data transmission and a secondary cell measurement configuration to the UE for the secondary cell addition. The one or more secondary cells are added at the UE based on the one or more configured network parameters. The apparatus may further perform at least one of a secondary cell activation and a secondary cell deactivation for the one or more added secondary cells based on the first threshold value (A). The apparatus may further transmit, after the secondary cell deactivation, at least one of a secondary cell removal command to eliminate the one or more added secondary cells and a removal of secondary cell measurement configuration for the secondary cell addition. The one or more added secondary cells are eliminated based on the one or more configured network parameters.

According to one embodiment of the present disclosure, a non-transitory computer-readable medium storing instructions, the instructions comprising: one or more instructions that, when executed by an apparatus, the apparatus comprising one or more processors. The one or more processors may establish a connection with a User Equipment (UE) for data transmission. A base station associated with the apparatus comprises a primary cell and one or more secondary cells. The one or more processors may further configure, at the primary cell, one or more network parameters. The one or more network parameters comprise a first threshold value (A), a second threshold value (B), and a configurable observation period (T) for the data transmission. The one or more processors may further transmit at least one of a secondary cell addition command to add the one or more secondary cells for the data transmission and a secondary cell measurement configuration to the UE for the secondary cell addition. The one or more secondary cells are added at the UE based on the one or more configured network parameters. The one or more processors may further perform at least one of a secondary cell activation and a secondary cell deactivation for the one or more added secondary cells based on the first threshold value (A). The one or more processors may further transmit, after the secondary cell deactivation, at least one of a secondary cell removal command to eliminate the one or more added secondary cells and a removal of secondary cell measurement configuration for the secondary cell addition. The one or more added secondary cells are eliminated based on the one or more configured network parameters.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF THE DRAWINGS

Features, aspects, and advantages of embodiments of the disclosure will be described below with reference to the accompanying drawings, in which like reference numerals denote like elements, and wherein:

FIGS. 1A-1B is a sequence flow diagram illustrating one or more operations associated with a blind SCell addition mechanism, according to prior art;

FIGS. 2A-2B is a sequence flow diagram illustrating one or more operations associated with a measurement-based SCell addition mechanism, according to prior art;

FIG. 3 is a sequence flow diagram illustrating a problem scenario associated with the existing SCell addition mechanism, especially for User Equipment (UE) with low throughput requirements, according to prior art;

FIGS. 4A-4B is a sequence flow diagram illustrating one or more operations associated with a disclosed blind SCell addition mechanism, according to an embodiment as disclosed herein; and

FIGS. 5A-5B is a sequence flow diagram illustrating one or more operations associated with a disclosed measurement-based SCell addition mechanism, according to an embodiment as disclosed herein;

FIG. 6 is a flow diagram illustrating a throughput based Secondary Cell (Scell) addition or measurement configuration method, according to an embodiment as disclosed herein; and

FIG. 7 illustrates a diagram of example components of an apparatus, according to an embodiment as disclosed herein.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

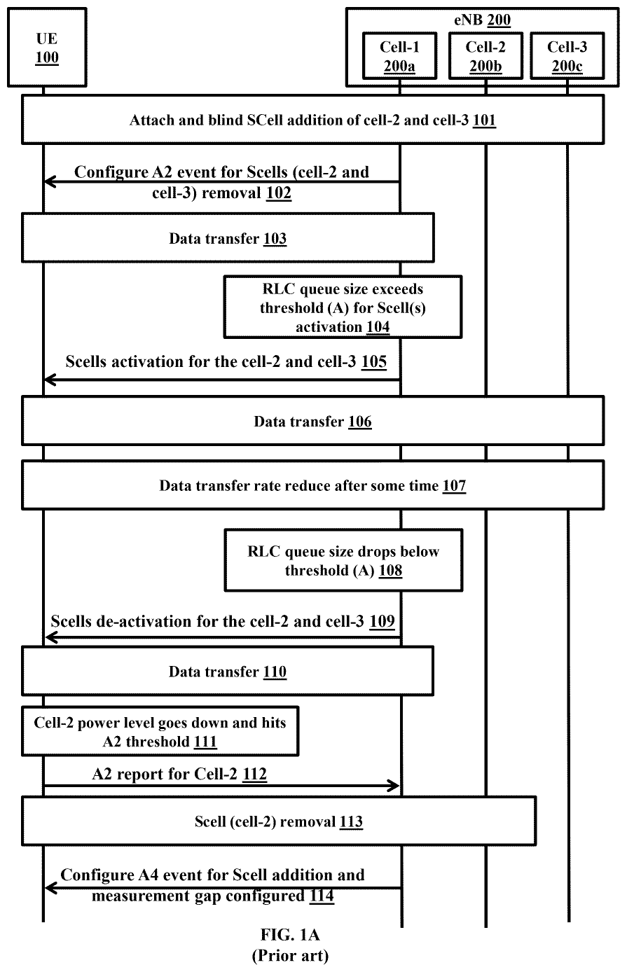

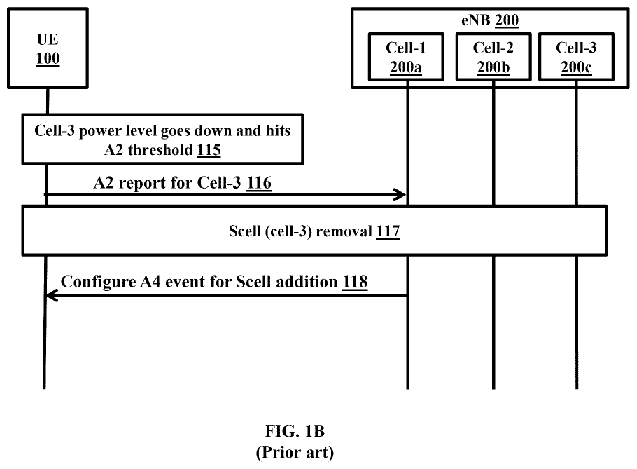

FIGS. 1A-1B is a sequence flow diagram illustrating one or more operations associated with a blind Secondary Cell (SCell) addition mechanism, according to prior art.

Referring to FIG. 1A: in telecommunication systems, various network entities collaborate to execute a blind Secondary Cell (SCell) addition mechanism by performing the one or more operations, which are given below. Examples of the network entities may include, but are not limited to, a User Equipment (UE) 100 and an evolved Node B (eNB) 200. The eNB 200 may include a primary cell (Cell-1) 200a and one or more secondary cells (Cell-2 200b and Cell-3 200c).

At operation 101, initially, the UE 100 may establish a connection with the Cell-1 200a. Following this connection, the Cell1-200a may initiate the blind SCell addition mechanism for additional cells, specifically Cell-2 200b and Cell-3 200c. At operation 102, in response, the eNB 200 transmits an A2 event to the UE 100, facilitating the removal of the specified secondary cells, in case, if their power level goes down. At operation 103, once the UE 100 is connected to the Cell-1 200a, a data transfer session commences between the UE 100 and the Cell-1 200a. At operations 104-105, during this data transfer, the eNB 200 monitors a Radio Link Control (RLC) queue size associated with SCell activation. If the RLC queue size surpasses a configurable threshold (denoted as threshold A), the Cell-1 200a issues a command to activate the secondary cells (i.e., Cell-2 200b and Cell-3 200c).

At operation 106, upon receipt of this activation command, the data transfer process expands to include both the Cell-1 200a and the newly activated secondary cells (i.e., Cell-2 200b and Cell-3 200c), thereby enhancing bandwidth and resource allocation. At operations 107-108, subsequently, the Cell-1 200a detects a reduction in data transfer requirements (low throughput requirements), indicated by a decrease in the RLC queue size falling below threshold A. At operations 109-110, consequently, the Cell-1 200a sends a command to deactivate the secondary cells (i.e., Cell-2 200b and Cell-3 200c). After the UE 100 acknowledges the deactivation command, the data transfer reverts to utilize only the Cell-1 200a.

At a later stage, at operations 111-112, the UE 100 may identify that a power level of Cell-2 200b has diminished, reaching an A2 threshold. In this instance, the UE 100 generates and transmits an A2 report specific to Cell-2 200b. At operations 113-114, upon receiving this A2 report, the eNB 200 or said Cell-1 200a initiates a removal process for SCell (Cell-2 200b) and subsequently transmits the relevant information pertaining to configure A4 event for the purpose of SCell addition and configuration of a measurement gap.

Referring to FIG. 1B: Similarly, at operations 115-116, the UE 100 may identify that a power level of Cell-3 200c has diminished, reaching an A2 threshold. In this instance, the UE 100 generates and transmits an A2 report specific to Cell-3 200c. At operations 117-118, upon receiving this A2 report, the Cell-1 200a initiates a removal process for SCell (i.e., Cell-3 200c) and subsequently transmits the relevant information pertaining to configure A4 event for the purpose of SCell addition and configuration of a measurement gap.

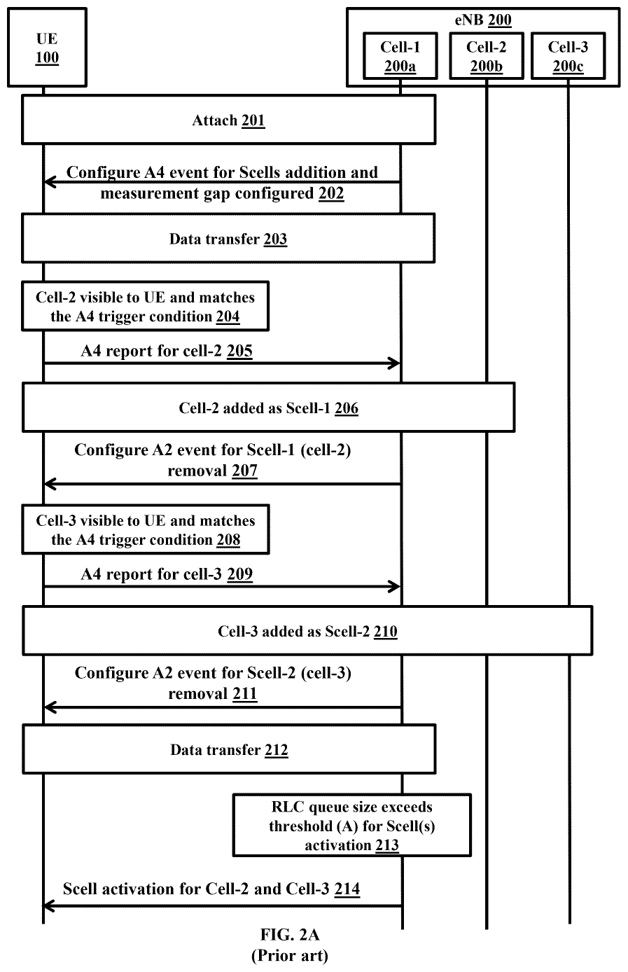

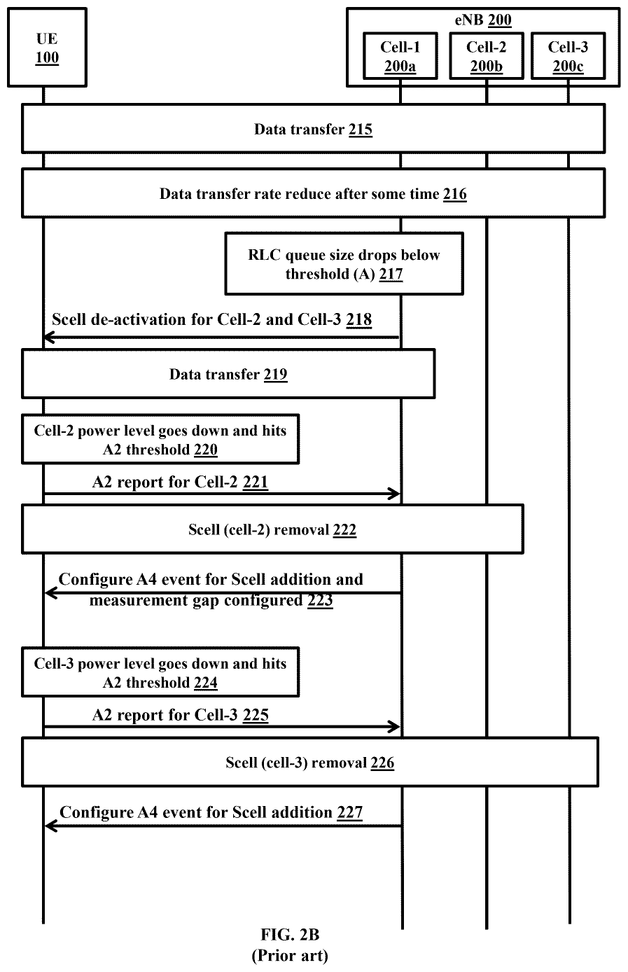

FIGS. 2A-2B is a sequence flow diagram illustrating one or more operations associated with a measurement-based SCell addition mechanism, according to prior art. The various network entities collaborate to execute the measurement-based SCell addition mechanism by performing the one or more operations, which are given below.

Referring to FIG. 2A: At operation 201, initially, the UE 100 may establish a connection with the Cell-1 200a. At operation 202, following this connection, the Cell-1 200a transmits configuration data related to the A4 event, which facilitates the addition of secondary cells (i.e., Cell-2 200b and Cell-3 200c) and the configuration of measurement gaps for the UE 100. At operation 203, once the UE 100 is connected to the Cell-1 200a, a data transfer session is initiated between them.

At operation 204, the UE 100 detects the presence of the Cell-2 200b, which meets the A4 trigger conditions previously communicated by the Cell-1 200a, referred to as an initiation of “measurement-based SCell addition mechanism for the Cell-2 200b”. At operations 205-206, in response, the UE 100 generates and transmits an A4 report for the Cell-2 200b back to the Cell-1 200a, resulting in the addition of the Cell-2 200b as the Scell-1. At operation 207, subsequently, the Cell-1 200a transmits configuration information pertinent to the A2 event, facilitating the removal of Scell-1 (i.e., Cell-2 200b), in case, if the power level of Scell-1 goes down. At operation 208, in a similar manner, the UE 100 identifies the Cell-3 200c, which also satisfies the A4 previously communicated by the Cell-1 200a, referred to as an initiation of “measurement-based SCell addition mechanism for the Cell-3 200c”. At operations 209-210, consequently, the UE 100 sends an A4 report for the Cell-3 200c to the Cell-1 200a, leading to the addition of the Cell-3 200c as the Scell-2. At operation 211, subsequently, the Cell-1 200a transmits configuration data regarding the A2 event for facilitating the removal of Scell-2 (i.e., Cell-3 200c), in case, if the power level of the Scell-2 goes down.

Now, after the measurement process, at operation 212, consider a scenario where a data transfer session commences between the UE 100 and the Cell-1 200a. At operations 213-214, during this data transfer, the eNB 200 or said Cell-1 200a monitors a Radio Link Control (RLC) queue size associated with SCell activation. If the RLC queue size surpasses a configurable threshold (denoted as threshold A), the Cell-1 200a issues a command to activate the secondary cells (i.e., Cell-2 200b and Cell-3 200c).

Referring to FIG. 2B: At operation 215, upon receipt of this activation command, the data transfer process expands to include both the Cell-1 200a and the newly activated secondary cells (i.e., Cell-2 200b and Cell-3 200c), thereby enhancing bandwidth and resource allocation. At operations 216-217, subsequently, the Cell-1 200a detects a reduction in data transfer requirements (low throughput requirements), indicated by a decrease in the RLC queue size falling below threshold A. At operations 218-219, the Cell-1 200a sends a command to deactivate the secondary cells (i.e., Cell-2 200b and Cell-3 200c). After the UE 100 acknowledges the deactivation command, the data transfer reverts to utilize only the Cell-1 200a.

At a later stage, at operations 220-221, the UE 100 may identify that a power level of Cell-2 200b has diminished, reaching an A2 threshold. In this instance, the UE 100 generates and transmits an A2 report specific to Cell-2 200b. At operations 222-223, upon receiving this A2 report, the eNB 200 or said Cell-1 200a initiates a removal process for SCell (Cell-2 200b) and subsequently transmits the relevant information pertaining to configure A4 event, for the purpose of SCell addition and configuration of a measurement gap.

At operations 224-225, the UE 100 may identify that a power level of Cell-3 200c has diminished, reaching an A2 threshold. In this instance, the UE 100 generates and transmits an A2 report specific to Cell-3 200c. At operations 226-227, upon receiving this report, the Cell-1 200a initiates a removal process for SCell (i.e., Cell-3 200c) and subsequently transmits the relevant information pertaining to configure A4 event, for the purpose of SCell addition and configuration of a measurement gap.

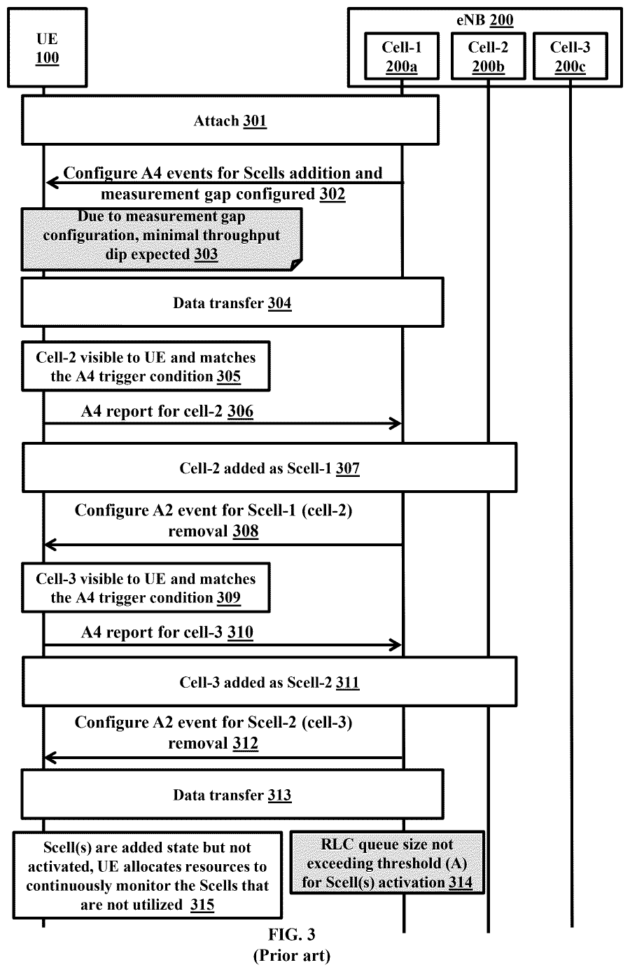

FIG. 3 is a sequence flow diagram illustrating a problem scenario associated with the existing SCell addition mechanism, especially for the UE 100 with low throughput requirements, according to the prior art. The sequence flow diagram includes several operations outlined as follows.

At operation 301, initially, the UE 100 establishes a connection with the Cell-1 200a. At operations 302-303, following this connection, the Cell-1 200a transmits configuration data pertaining to the A4 event, which enables the addition of secondary cells (i.e., Cell-2 and Cell-3) and the configuration of measurement gaps for the UE 100. This measurement gap configuration is expected to result in a minimal dip in throughput. At operation 304, once the UE 100 is connected to the Cell-1 200a, a data transfer session is initiated between them.

At operation 305, the UE 100 detects the Cell-2 200b, which meets the A4 trigger conditions previously communicated by the Cell-1 200a. At operations 306-307, in response, the UE 100 generates and transmits an A4 report for the Cell-2 200b back to the Cell-1 200a, resulting in the addition of the Cell-2 200b as the Scell-1. At operation 308, subsequently, the Cell-1 200a transmits configuration information related to the A2 event, facilitating the removal of Scell-1 (i.e., Cell-2 200b) if its power level goes down.

At operation 309, similarly, when the UE 100 identifies the Cell-3 200c, which also meets the A4 trigger conditions previously communicated by the Cell-1 200a. At operations 310-311, in response, the UE 100 generates and transmits an A4 report for the Cell-3 200c back to the Cell-1 200a, resulting in the addition of the Cell-3 200c as the Scell-1. At operation 312, subsequently, the Cell-1 200a transmits configuration information related to the A2 event, facilitating the removal of Scell-2 (i.e., Cell-3 200c) if its power level goes down. At operation 313, After the measurement process, consider a scenario in which a data transfer session commences between the UE 100 and the Cell-1 200a. The At operation 314, RLC queue size is not exceeding the defined threshold (A) for the activation of secondary cells. At operation 315, although the secondary cells (i.e., Cell-2 200b and Cell-3 200c) are in an added state, they are not activated, resulting in the UE 100 allocating resources to continuously monitor these secondary cells (i.e., Cell-2 200b and Cell-3 200c), which remain underutilized.

Carrier Aggregation (CA) in telecommunications offers several advantages. The CA enhances data throughput by enabling the simultaneous use of multiple carriers, thus increasing bandwidth and improving user experience. The mechanisms for SCell addition, such as Blind SCell Addition and Measurement-Based SCell Addition, allow for flexible and efficient resource allocation, ensuring that UEs can connect to optimal cells based on their current needs. This dynamic management optimizes network performance, reduces latency, and improves overall service quality, particularly for high-demand applications, while also conserving resources by adapting to varying user requirements.

Despite advancements in SCell addition mechanisms within existing telecommunications systems, several challenges remain, especially for the UE 100 with low throughput requirements, as shown in FIGS. 1A-1B, FIGS. 2A-2B, and FIG. 3. For these UEs, adding SCells may be unnecessary, leading to inefficient use of network resources. Configuring SCell addition measurements requires measurement gaps, which can reduce overall throughput due to the time spent in idle listening states. Both blind SCell addition and measurement-based SCell addition can result in significant energy consumption by the UE 100 that stays in a listening mode for SCell signals. This extended listening drains battery life of the UE 100 and also causes resource wastage on an evolved Node B (eNB) side, as SCells may be allocated but not effectively used by the UE 100.

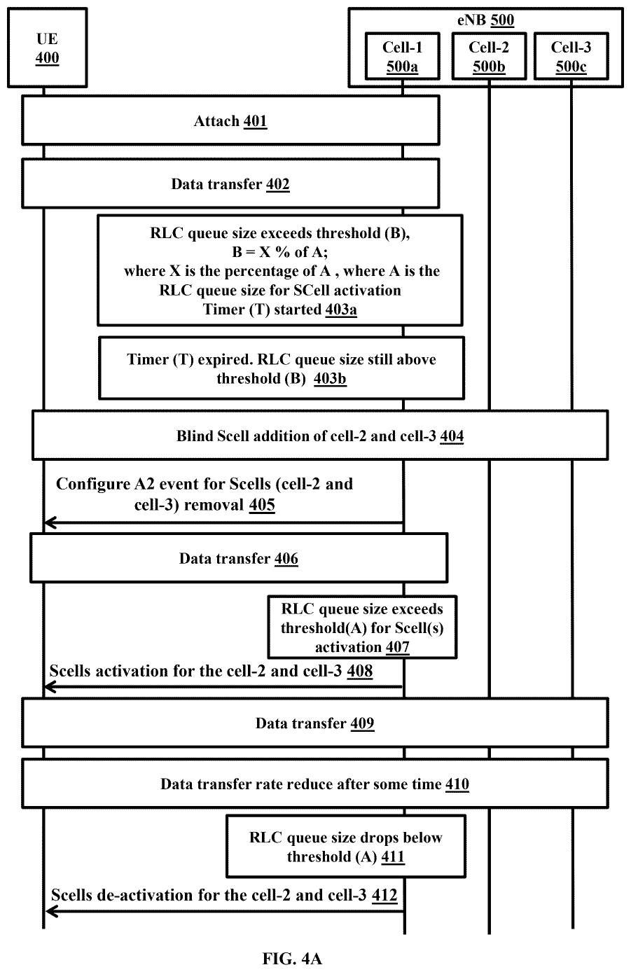

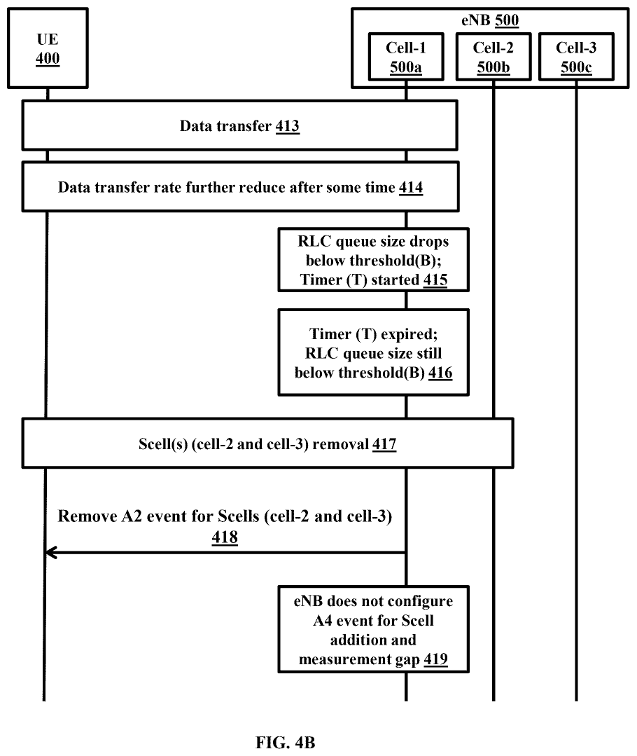

Thus, it is desired to address the above-mentioned disadvantages or other shortcomings or at least provide a useful alternative for the SCell addition or measurement configuration, as described in conjunction with FIGS. 4A-7.

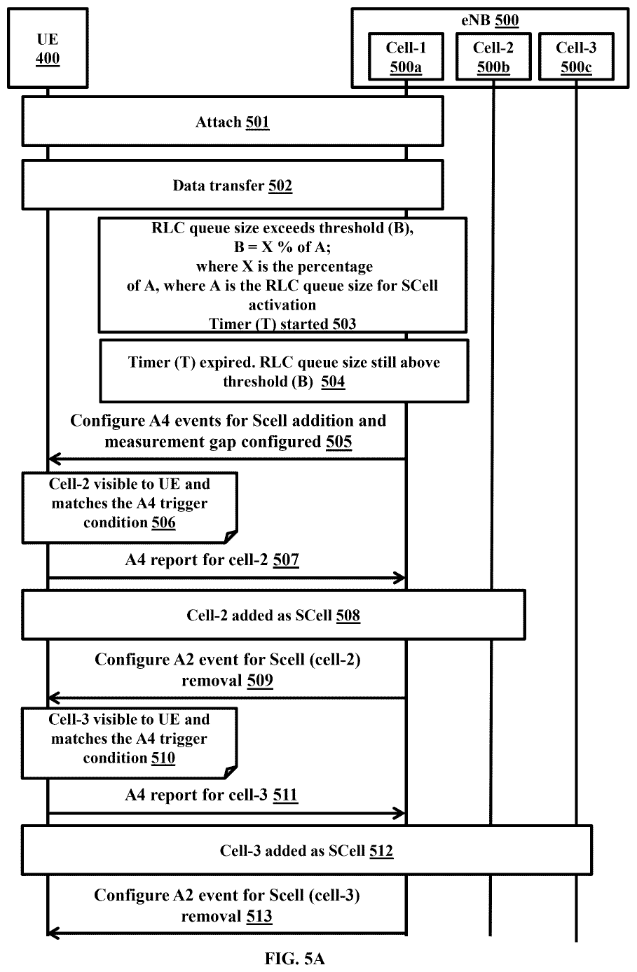

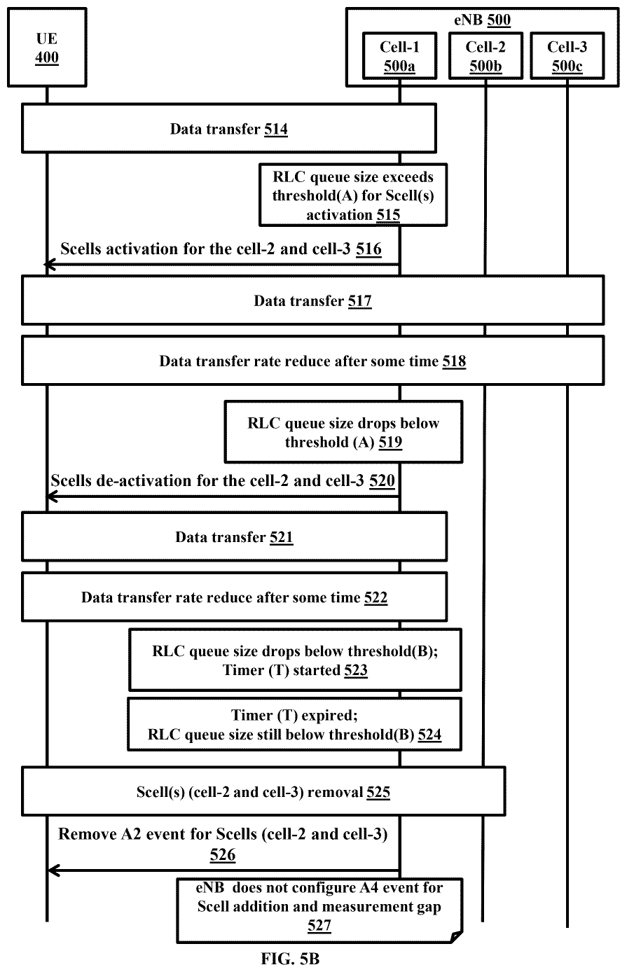

In one or more embodiments, the disclosed method introduces a throughput-based configuration for SCell addition and SCell addition measurement configuration, aimed at minimizing unnecessary SCell additions, as described in conjunction with FIGS. 4A-4B and FIGS. 5A-5B. When a RLC queue size reaches a configurable second threshold value (B), the RLC queue size is monitored for a specified duration (T) (i.e., configurable observation period (T)). The threshold (B) is calculated as a percentage (X) of the RLC queue size associated with SCell activation (A), where X typically ranges from 50% to 95%. For instance, B may be set to 80% of the RLC queue size (A) for SCell activation.

If the RLC queue size remains above the threshold (B) throughout the entire configurable observation period (T), SCell addition (A4 event) measurements can be configured for the User Equipment (UE), or SCells can be added directly in the case of blind SCell addition if this feature is enabled. Conversely, if the RLC queue size falls below the threshold (B) and remains below it for the configurable observation period (T), SCells may be released, or SCell addition (A4 event) measurements can be removed if the SCells have not been added.

In one or more embodiments, the disclosed method is designed to reduce redundant RRC message exchanges between the UE and eNB, thereby determining the necessity of CA for the UE. It is important to note that this approach is not intended for every SCell addition or release.

Referring now to the drawings, and more particularly to FIGS. 4A to 7, where similar reference characters denote corresponding features consistently throughout the figures, there are shown preferred embodiments.

FIGS. 4A-4B is a sequence flow diagram illustrating one or more operations associated with a disclosed blind SCell addition mechanism, according to an embodiment as disclosed herein. The sequence flow diagram includes several operations outlined as follows.

Referring to FIG. 4A: At operation 401, initially, a UE 400 may establish a connection with a Cell-1 500a of an eNB 500, designated as the primary cell. At operation 402, following this connection, a data transmission is initiated between the UE 400 and the Cell-1 500a. At operations 403a-403b, during this data transmission, the Cell-1 500a may continuously monitor a Radio Link Control (RLC) queue size associated with the data transmission by utilizing various network parameters. The network parameters may include a first threshold value (A), a second threshold value (B), and a configurable observation period (T) for the data transmission. The Cell-1 500a may determine whether the RLC queue size remains above the second threshold value (B) throughout the configurable observation period (T). At operation 404, in response to the determination that the RLC queue size consistently exceeds the secondary threshold value (B) during the configurable observation period, the Cell-1 500a directly configures one or more secondary cells (i.e., Cell-2 500b and Cell-3 500c). This configuration is applied to the UE 400 for data transmission, particularly when the secondary cells are classified as the first type (i.e., blind cells).

At operation 405, the Cell-1 500a may transmit an A2 event to the UE 400, facilitating the removal of Scell(s) (e.g., Cell-2 500b and Cell-3 500c) if the power level goes down . At operation 406, once the UE 400 is connected to the Cell-1 500a, a data transfer session may initiate between the UE 400 and the Cell-1 500a. At operations 407-408, during this data transfer, the Cell-1 500a may monitor the RLC queue size associated with SCell activation. If the RLC queue size surpasses the configurable threshold (denoted as threshold A), the Cell-1 500a may issue a command to activate the secondary cells (i.e., Cell-2 500b and Cell-3 500c).

At operation 409, upon receipt of this activation command, the data transfer process expands to include both the Cell-1 500a and the newly activated secondary cells (i.e., Cell-2 500b and Cell-3 500c), thereby enhancing bandwidth and resource allocation. At operations 410-411, subsequently, the Cell-1 500a may detect a reduction in data transfer requirements (low throughput requirements), indicated by a decrease in the RLC queue size falling below threshold A. At operation 412, consequently, the Cell-1 500a may transmit a command to deactivate the secondary cells (i.e., Cell-2 500b and Cell-3 500c).

Referring to FIG. 4B: At operation 413, after the UE 400 may acknowledge the deactivation command, the data transfer reverts to utilize only the Cell-1 500a. At operation 414, the Cell-1 500a may further detect the reduction in data transfer requirements (low throughput requirements). At operations 415-416, the Cell-1 500a may determine whether the RLC queue size remains below the second threshold value (B) throughout the configurable observation period (T). At operation 417, in response to the determination that the RLC queue size is consistently below the secondary threshold value (B) during the configurable observation period (T), the Cell-1 500a may initiate a process to remove one or more added secondary cells (i.e., Cell-2 500b and Cell-3 500c). At operations 418-419, the Cell-1 500a transmits a signal for the removal of the configured A2 event to the UE 400. The Cell-1 500a does not configure A4 event for Scell addition and measurement gap.

FIGS. 5A-5B is a sequence flow diagram illustrating one or more operations associated with a disclosed measurement-based SCell addition mechanism, according to an embodiment as disclosed herein. The sequence flow diagram includes several operations outlined as follows.

Referring to FIG. 5A: At operation 501, initially, a UE 400 may establish a connection with the Cell-1 500a, designated as the primary cell. At operation 502, following this connection, a data transmission is initiated between the UE 400 and the Cell-1 500a. At operations 503-504, during this data transmission, the Cell-1 500a may continuously monitor the RLC queue size associated with the data transmission by utilizing various network parameters. The network parameters may include the first threshold value (A), the second threshold value (B), and the configurable observation period (T) for the data transmission. The Cell-1 500a may determine whether the RLC queue size remains above the second threshold value (B) throughout the configurable observation period (T). At operation 505, in response to the determination that the RLC queue size consistently exceeds the secondary threshold value (B) during the configurable observation period (T), the Cell-1 500a transmits a secondary cell addition measurement configuration information for the purpose of secondary cell addition. The measurement configuration information is transmitted to the UE 400 to add the one or more secondary cells for the data transmission upon UE reporting the measurement, when the one or more secondary cells are classified as a second type of secondary cell (i.e., measurement-based Scell addition).

At operation 506, after a specified interval, the UE 400 detects the presence of the Cell-2 500b, which meets the A4 trigger conditions previously communicated by the Cell-1 500a, referred to as an initiation of “measurement-based SCell addition mechanism for the Cell-2 500b”. At operations 507-508, in response, the UE 400 generates and transmits an A4 report for the Cell-2 500b back to the Cell-1 500a, resulting in the addition of the Cell-2 500a as the Scell-1. At operation 509, subsequently, the Cell-1 500a transmits configuration information pertinent to the A2 event, to facilitate the removal of Scell-1 (i.e., Cell-2 500b) if the signal condition becomes worse. At operation 510, in a similar manner, after another specified interval, the UE 400 identifies the Cell-3 500c, which also satisfies the A4 previously communicated by the Cell-1 500a, referred to as an initiation of “measurement-based SCell addition mechanism for the Cell-3 500c”. At operations 511-512, consequently, the UE 400 sends an A4 report for the Cell-3 500c to the Cell-1 500a, leading to the addition of the Cell-3 500c as the Scell-2. At operation 513, subsequently, the Cell-1 500a transmits configuration data regarding the A2 event to facilitate the removal of Scell-2 (i.e., Cell-3 500c) if the signal condition becomes worse.

Referring to FIG. 5B: After the measurement process, at operation 514, consider a scenario where a data transfer session initiates between the UE 400 and the Cell-1 500a. At operations 515-516, during this data transfer, the Cell-1 500a monitors the RLC queue size associated with SCell activation. If the RLC queue size surpasses a configurable threshold (denoted as threshold A), the Cell-1 500a issues a command to activate the secondary cells (i.e., Cell-2 500b and Cell-3 500c).

At operation 517, upon receipt of this activation command, the data transfer process expands to include both the Cell-1 500a and the newly activated secondary cells (i.e., Cell-2 500b and Cell-3 500c), thereby enhancing bandwidth and resource allocation. At operations 518-519, subsequently, the Cell-1 500a detects a reduction in data transfer requirements (low throughput requirements), indicated by a decrease in the RLC queue size falling below threshold A. At operations 520-521, the Cell-1 500a sends a command to deactivate the secondary cells (i.e., Cell-2 500b and Cell-3 500c). After the UE 400 acknowledges the deactivation command, the data transfer reverts to utilize only the Cell-1 500a.

At operation 522, the Cell-1 500a may further detect the reduction in data transfer requirements (low throughput requirements). At operations 523-524, the Cell-1 500a may determine whether the RLC queue size remains below the second threshold value (B) throughout the configurable observation period (T). At operation 525, in response to the determination that the RLC queue size is consistently below the secondary threshold value (B) during the configurable observation period, the Cell-1 500a may initiate a process to remove one or more added secondary cells (i.e., Cell-2 500b and Cell-3 500c). At operations 526-527, the Cell-1 500a transmits a signal for the removal of the configured A2 event to the UE 400. The Cell-1 500a does not configure A4 event for Scell addition and measurement gap.

In the above-mentioned scenarios (referred to FIG. 4B and FIG. 5B), the Cell-1 500a transmits a signaling message to the UE 400 to remove specified Scells (e.g., Cell-2 500b and Cell-3 500c) and the Configured A2 event, and not configuring the A4 event for Scell addition and measurement gaps. This disclosed method offered several advantages. Firstly, the disclosed method optimizes resource utilization by freeing up bandwidth, allowing for more efficient management of available resources. This is particularly advantageous in situations where certain Scells are no longer necessary, thereby preventing network congestion and ensuring optimal performance for active connections. Secondly, the decision not to configure the A4 event simplifies the signaling process, leading to faster decision-making and reduced overhead in managing Scell configurations. This streamlined operation benefits both the eNB 500 and the UE 400. Additionally, efficient management of Scell configurations enhances the user experience by maintaining a stable and reliable connection. By removing unnecessary Scells, the network minimizes potential interference, allowing the UE 400 to focus on the most effective channels for data transmission.

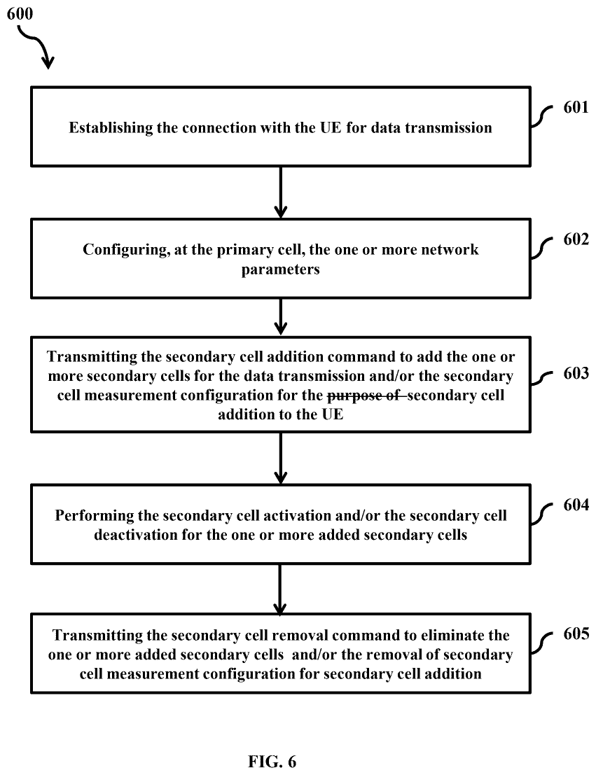

FIG. 6 is a flow diagram illustrating a throughput based Scell addition or measurement configuration method, according to an embodiment as disclosed herein. The flow diagram includes several operations outlined as follows.

At operation 601, the method 600 includes establishing, by the primary cell 500a of the base station 500 (e.g., eNB), a connection with the UE 400 for data transmission. The base station 500 comprises the primary cell 500a and one or more secondary cells (e.g., 500b and 500c). At operation 602, the method 600 further includes configuring, at the primary cell 500a, one or more network parameters. The one or more network parameters may include the first threshold value (A), the second threshold value (B), and the configurable observation period (T) for the data transmission. At operation 603, the method 600 includes further includes transmitting, by the primary cell 500a, at least one of a secondary cell addition command to add the one or more secondary cells (e.g., 500b and/or 500c) for the data transmission and a secondary cell measurement configuration to the UE 400 for the secondary cell addition. The one or more secondary cells are added at the UE 400 based on the one or more configured network parameters. At operation 604, the method 600 further includes performing, by the primary cell 500a, at least one of a secondary cell activation and a secondary cell deactivation for the one or more added secondary cells based on the first threshold value (A). At operation 605, the method 600 includes further includes transmitting, after the secondary cell deactivation, by the primary cell 500a, at least one of a secondary cell removal command to eliminate the one or more added secondary cells (e.g., 500b and/or 500c) and a removal of secondary cell measurement configuration for the secondary cell addition. The one or more added secondary cells are eliminated based on the one or more configured network parameters. Further, a detailed description related to the various operations of FIG. 6 is covered in the description related to FIGS. 4A-4B, and FIGS. 5A-5B, and is omitted herein for the sake of brevity.

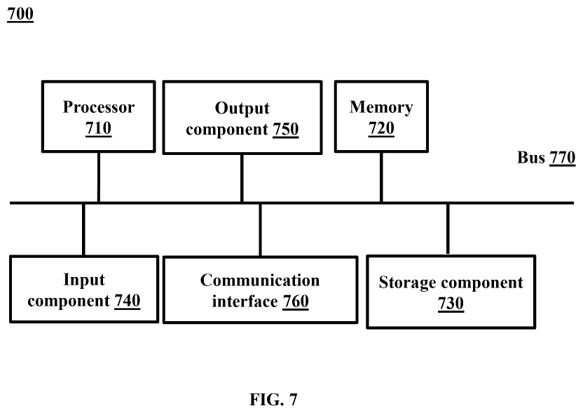

FIG. 7 illustrates a diagram of example components of an apparatus 700, according to an embodiment as disclosed herein. As shown in FIG. 7, the apparatus 700 comprises a processor 710, a memory 720, a storage component 730, an input component 740, an output component 750, a communication interface 760, and a bus 770. In one embodiment, the apparatus 700 may relate to at least one of the eNB 500, or any other network device.

The processor 710, as used herein, means any type of computational circuit that may comprise hardware elements and software elements. The processor 710 may be embodied as a multi-core processor, a single core processor, or a combination of one or more multi-core processors and/or one or more single core processors, a distributed processing system, or the like. The processor 710 may be a Central Processing Unit (CPU), a Graphics Processing Unit (GPU), an Accelerated Processing Unit (APU), an Application-Specific Integrated Circuit (ASIC), or another type of processing component.

The memory 720 includes a non-transitory computer readable medium. Memory 720 includes a Random-Access Memory (RAM), a Read Only Memory (ROM), and/or another type of dynamic or static storage device (e.g., a flash memory, a magnetic memory, and/or an optical memory) that stores information and/or instructions for use by processor 710. The memory 720 comprises machine-readable instructions which are executable by the processor 710. These machine-readable instructions when executed by the processor 710 cause the processor 710 to perform one or more method steps of an embodiment described above.

The storage component 730 stores information and/or software related to the operation and use of the apparatus 700. For example, the storage component 730 may include a hard disk (e.g., a magnetic disk, an optical disk, a magneto-optic disk, and/or a solid-state disk), a Compact Disc (CD), a Digital Versatile Disc (DVD), a floppy disk, a cartridge, a magnetic tape, and/or another type of non-transitory computer-readable medium, along with a corresponding drive.

The input component 740 is configured to receive information, such as user input. For example, the input component 740 may include, but not be limited to, a touch screen display, a keyboard, a keypad, a mouse, a button, a switch, and/or a microphone. Additionally, or alternatively, the input component 740 may include a sensor for sensing information (e.g., a Global Positioning System (GPS), an accelerometer, a gyroscope, and/or an actuator).

The output component 750 is configured to provide output information from the apparatus 700. For example, the output component 750 may be, but is not limited to, a display, a speaker, instructions to an external device, and/or one or more Light-Emitting Diodes (LEDs).

The communication interface 760 is an interface that provides a communication connection to other devices, such as external devices and internal devices. The connection by the communication interface 760 can be a wired connection, a wireless connection, or a combination of wired and wireless connections, and can be a direct connection or an indirect connection via a communication network that exists between the apparatus 700 and other devices. In other words, the standard of the communication interface 760 is not limited.

The bus 770 acts as an interconnect between the processor 710, the memory 720, the storage component 730, the input component 740, the output component 750, and the communication interface 760 of the apparatus 700. The bus 770 may include a wired interconnection or a wireless interconnection.

The number and arrangement of components shown in FIG. 7 are provided as an example. In practice, the apparatus 700 may include additional components, fewer components, different components, or differently arranged components than those shown in FIG. 7. Additionally, or alternatively, a set of components (e.g., one or more components) of the apparatus may perform one or more functions described as being performed by another set of components of the apparatus 700. Further, one or more method steps described in any of the embodiments may be performed utilizing the apparatus 700 in communication with one another.

The disclosed/method/apparatus has several advantages over the existing mechanism, for example, which are stated below,
a. Efficient resource management: By using a throughput-based configuration, the disclosed method ensures that SCell additions are only made when necessary, preventing unnecessary resource usage.
b. Enhance network performance: The disclosed method helps in determining the need for carrier aggregation based on real-time RLC queue sizes, allowing for dynamic adjustments that enhance user experience. By monitoring the RLC queue size and adjusting SCell additions accordingly, the network can maintain optimal performance levels, reducing the chance of congestion or underutilization.
c. Selective SCell management: The disclosed method allows for the release of SCells if the conditions are not met, ensuring that only necessary resources are utilized, which can lead to better network management.
d. Energy and resource efficiency: This disclosed method for SCell addition ensures that SCells are activated only upon reaching specific throughput thresholds. This selective activation significantly mitigates energy consumption and resource utilization for both the UE 400 and the eNB 500. In addition, the disclosed method optimizes battery longevity for mobile devices (e.g., UE 400) and reduces operational expenditures for network operators. Furthermore, the eNB 500 can conserve resources by minimizing the overhead associated with managing inactive SCells, thereby fostering a more sustainable and efficient network operation.

Examples of the techniques and apparatus described herein include, but are not limited to, the following enumerated embodiments:
[1] A method (600) comprising:
   establishing (601), by a primary cell (500a) of a base station (500), a connection with a User Equipment (UE) (400) for data transmission, wherein the base station (500) comprises the primary cell (500a) and one or more secondary cells (500b and/or 500c);
   configuring (602), at the primary cell (500a), one or more network parameters comprising a first threshold value (A), a second threshold value (B), and a configurable observation period (T) for the data transmission;
   transmitting (603), by the primary cell (500a), at least one of a secondary cell addition command to add the one or more secondary cells (500b and/or 500c) for the data transmission and a secondary cell measurement configuration to the UE (400) for the secondary cell addition,, based on the one or more configured network parameters;
   performing (604), by the primary cell (500a), at least one of a secondary cell activation and a secondary cell deactivation for the one or more added secondary cells (500b and/or 500c) based on the first threshold value (A); and
   transmitting (605), after the secondary cell deactivation, by the primary cell (500a), at least one of a secondary cell removal command to eliminate the one or more added secondary cells (500b and/or 500c) and a removal of secondary cell measurement configuration for the secondary cell addition,, based on the one or more configured network parameters.
[2] The method (600) as described in [1], wherein transmitting at least one of the secondary cell addition command to add the one or more secondary cells (500b and/or 500c) for the data transmission and the secondary cell measurement configuration to the UE (400) for the secondary cell addition, comprises:
   continuously monitoring a Radio Link Control (RLC) queue size associated with the data transmission between the UE (400) and the primary cell (500a);
   determining whether the RLC queue size remains above the second threshold value (B) throughout the configurable observation period (T) and a type of the secondary cell; performing at least one of:
      transmitting measurement configuration information in response to determining that the RLC queue size remains above the second threshold value (B) throughout the configurable observation period (T),
         wherein the measurement configuration information is transmitted to the UE (400) to add the one or more secondary cells (500b and/or 500c) for the data transmission upon UE reporting the measurement, when the one or more secondary cells (500b and/or 500c) are classified as a second type of secondary cell; or
      directly adding the one or more secondary cells (500b and/or 500c) configuration in response to determining that the RLC queue size remains above the second threshold value (B) throughout the configurable observation period (T),
         wherein the one or more secondary cells (500b and/or 500c) configuration is added directly in the UE (400) for the data transmission when the one or more secondary cells (500b and/or 500c) are classified as a first type of secondary cell.
[3] The method (600) as described in any of [1]-[2], wherein performing the secondary cell activation for the one or more added secondary cells (500b and/or 500c) based on the first threshold value (A) comprises:
   determining whether a Radio Link Control (RLC) queue size remains above the first threshold value (A); and
   transmitting a secondary cell activation command to the UE (400) in response to determining that the RLC queue size remains above the first threshold value (A),
      wherein the secondary cell activation command indicates that the UE (400) utilizes one or more resources associated with each cell of the base station (500) for the data transmission.
[4] The method (600) as described in any of [1]-[3], wherein performing the secondary cell deactivation for the one or more added secondary cells (500b and/or 500c) based on the first threshold value (A) comprises:
   determining whether a Radio Link Control (RLC) queue size does not remain above the first threshold value (A); and
   transmitting a secondary cell deactivation command to the UE (400) in response to determining that the RLC queue size does not remain above the first threshold value (A),
      wherein the secondary cell deactivation command indicates that the UE (400) utilizes one or more resources associated solely with the primary cell (500a) of the base station (500) for the data transmission.
[5] The method (600) as described in any of [1]-[4], wherein transmitting the secondary cell removal command, to eliminate the one or more added secondary cells (500b and/or 500c), based on the one or more configured network parameters comprises:
   continuously monitoring a Radio Link Control (RLC) queue size associated with the data transmission between the UE (400) and the primary cell (500a);
   determining whether the RLC queue size remains below the second threshold value (B) throughout the configurable observation period (T); and
   removing the one or more secondary cells (500b and/or 500c) configuration in response to determining that the RLC queue size does not remain above the second threshold value (B) throughout the configurable observation period (T),
      wherein the one or more secondary cells (500b and/or 500c) configuration is removed directly in the UE (400) for the data transmission.
[6] The method (600) as described in any of [1]-[5], wherein transmitting the removal of measurement configuration for the secondary cell addition, based on the one or more configured network parameters comprises:
   continuously monitoring a Radio Link Control (RLC) queue size associated with the data transmission between the UE (400) and the primary cell (500a);
   determining whether the RLC queue size remains below the second threshold value (B) throughout the configurable observation period (T); and
   removing the one or more secondary cells (500b and/or 500c) measurement configuration in response to determining that the RLC queue size does not remain above the second threshold value (B) throughout the configurable observation period (T),
      wherein the one or more secondary cells (500b and/or 500c) measurement configuration is removed in the UE (400) where the one or more secondary cells (500b and/or 500c) are classified as a second type of secondary cell.
[7] The method (600) as described in any of [1]-[6], comprising:
   wherein the first threshold value (A) represents a size of a Radio Link Control (RLC) queue required to activate or deactivate the one or more secondary cells (500b and/or 500c);
   wherein the second threshold value (B) is defined as a configurable percentage of the first threshold value (A),
   wherein the second threshold value (B) is utilized to add or remove the one or more secondary cells (500b and/or 500c); and wherein the second threshold value (B) is utilized to configure or remove the one or more secondary cell measurement configurations for the one or more secondary cells (500b and/or 500c) classified as a second type of secondary cell.
[8] The method (600) as described in any of [1]-[7], wherein the one or more secondary cells (500b and/or 500c) are classified into either a first type of secondary cell or a second type of secondary cell.
[9] The method (600) as described in any of [1]-[8], further comprising:
   for a second type of secondary cell, in response to transmitting configuration information to remove the measurement configuration or not to configure measurement configuration to add the one or more secondary cells (500b and/or 500c), by the primary cell (500a), a measurement gap configuration is avoided;
   for a first type of secondary cell, avoid configuring secondary cells (500b and/or 500c) addition command directly, by the primary cell (500a), for a better radio utilization at the base station (500) and energy saving at the UE (400); and
   for the first type of secondary cell or the second type of secondary cell, removing the one or more added secondary cells (500b and/or 500c) configuration, by the primary cell (500a), for a better radio utilization at the base station (500) and energy saving at the UE (400).
[10] The method (600) as described in any of [1]-[9], wherein the UE (400) supports a carrier aggregation and a carrier aggregation feature is enabled at the base station (500) for the data transmission.
[11] An apparatus (700), the apparatus (700) is configured to:
   establish a connection with a User Equipment (UE) (400) for data transmission, wherein the base station (500) comprises the primary cell (500a) and one or more secondary cells (500b and/or 500c);
   configure one or more network parameters comprising a first threshold value (A), a second threshold value (B), and a configurable observation period (T) for the data transmission;
   transmit at least one of a secondary cell addition command to add the one or more secondary cells (500b and/or 500c) for the data transmission, and a secondary cell measurement configuration to the UE (400) for the secondary cell addition, based on the one or more configured network parameters;
   perform at least one of a secondary cell activation and a secondary cell deactivation for the one or more added secondary cells (500b and/or 500c) based on the first threshold value (A); and
   transmit, after the secondary cell deactivation, at least one of a secondary cell removal command to eliminate the one or more added secondary cells (500b and/or 500c), and a removal of secondary cell measurement configuration for the secondary cell addition, based on the one or more configured network parameters.
[12] The apparatus (700) as described in [11], wherein to transmit the at least one of the secondary cell addition command to add the one or more secondary cells (500b and/or 500c), and the secondary cell measurement configuration to the UE (400) for the secondary cell addition, the apparatus (700) is configured to:
   continuously monitor a Radio Link Control (RLC) queue size associated with the data transmission between the UE (400) and the primary cell (500a);
   determine whether the RLC queue size remains above the second threshold value (B) throughout the configurable observation period (T) and a type of the secondary cell;
   perform at least one of:
      transmit measurement configuration information in response to determining that the RLC queue size remains above the second threshold value (B) throughout the configurable observation period (T),
         wherein the measurement configuration information is transmitted to the UE (400) to add the one or more secondary cells (500b and/or 500c) for the data transmission upon UE reporting the measurement, when the one or more secondary cells (500b and/or 500c) are classified as a second type of secondary cell; or
      directly add the one or more secondary cells (500b and/or 500c) configuration in response to determining that the RLC queue size remains above the second threshold value (B) throughout the configurable observation period (T),
         wherein the one or more secondary cells (500b and/or 500c) configuration is added directly in the UE (400) for the data transmission when the one or more secondary cells (500b and/or 500c) are classified as a first type of secondary cell.
[13] The apparatus (700) as described in any of [11]-[12], wherein to perform the secondary cell activation for the one or more added secondary cells (500b and/or 500c) based on the first threshold value (A), the apparatus (700) is configured to:
   determine whether a Radio Link Control (RLC) queue size remains above the first threshold value (A); and
   transmit a secondary cell activation command to the UE (400) in response to determining that the RLC queue size remains above the first threshold value (A),
      wherein the secondary cell activation command indicates that the UE (400) utilizes one or more resources associated with each cell of the base station (500) for the data transmission.
[14] The apparatus (700) as described in any of [11]-[13], wherein to perform the secondary cell deactivation for the one or more added secondary cells (500b and/or 500c) based on the first threshold value (A), the apparatus (700) is configured to:
   determine whether a Radio Link Control (RLC) queue size does not remain above the first threshold value (A); and
   transmit a secondary cell deactivation command to the UE (400) in response to determining that the RLC queue size does not remain above the first threshold value (A),
      wherein the secondary cell deactivation command indicates that the UE (400) utilizes one or more resources associated solely with the primary cell (500a) of the base station (500) for the data transmission.
[15] The apparatus (700) as described in any of [11]-[14], wherein to transmit the secondary cell removal command to eliminate the one or more added secondary cells (500b and/or 500c), based on the one or more configured network parameters, the apparatus (700) is configured to:
   continuously monitor a Radio Link Control (RLC) queue size associated with the data transmission between the UE (400) and the primary cell (500a);
   determine whether the RLC queue size remains below the second threshold value (B) throughout the configurable observation period (T); and
   remove the one or more secondary cells (500b and/or 500c) configuration in response to determining that the RLC queue size does not remain above the second threshold value (B) throughout the configurable observation period (T),
      wherein the one or more secondary cells (500b and/or 500c) configuration is removed directly in the UE (400) for the data transmission.
[16] The apparatus (700) as described in any of [11]-[15], wherein to transmit the removal of measurement configuration for the secondary cell addition, based on the one or more configured network parameters, the apparatus (700) is configured to:
   continuously monitor a Radio Link Control (RLC) queue size associated with the data transmission between the UE (400) and the primary cell (500a);
   determine whether the RLC queue size remains below the second threshold value (B) throughout the configurable observation period (T); and
   remove the one or more secondary cells (500b and/or 500c) measurement configuration in response to determining that the RLC queue size does not remain above the second threshold value (B) throughout the configurable observation period (T),
      wherein the one or more secondary cells (500b and/or 500c) measurement configuration is removed in the UE (400) where the one or more secondary cells (500b and/or 500c) are classified as a second type of secondary cell.
[17] The apparatus (700) as described in any of [11]-[16], comprising:
   wherein the first threshold value (A) represents a size of a Radio Link Control (RLC) queue required to activate or deactivate the one or more secondary cells (500b and/or 500c);
   wherein the second threshold value (B) is defined as a configurable percentage of the first threshold value (A),
   wherein the second threshold value (B) is utilized to add or remove the one or more secondary cells (500b and/or 500c); and
   wherein the second threshold value (B) is utilized to configure or remove the one or more secondary cell measurement configurations for the one or more secondary cells (500b and/or 500c) classified as a second type of secondary cell.
[18] The apparatus (700) as described in any of [11]-[17], wherein the one or more secondary cells (500b and/or 500c) are classified into either a first type of secondary cell or a second type of secondary cell.
[19] The apparatus (700) as described in any of [11]-[18], further comprising:
   for a second type of secondary cell, in response to transmitting configuration information to remove the measurement configuration or not to configure measurement configuration to add the one or more secondary cells (500b and/or 500c), by the primary cell (500a), a measurement gap configuration is avoided;
   for a first type of secondary cell, avoid configuring secondary cells (500b and/or 500c) addition command directly, by the primary cell (500a), for a better radio utilization at the base station (500) and energy saving at the UE (400); and
   for the first type of secondary cell or the second type of secondary cell, removing the one or more added secondary cells (500b and/or 500c) configuration, by the primary cell (500a), for a better radio utilization at the base station (500) and energy saving at the UE (400).
[20] A non-transitory computer-readable medium storing instructions, the instructions comprising: one or more instructions that, when executed by an apparatus (700), the s apparatus (700) comprising one or more processors, cause the one or more processors to:
   establish a connection with a User Equipment (UE) (400) for data transmission, wherein the base station (500) comprises the primary cell (500a) and one or more secondary cells (500b and/or 500c);
   configure one or more network parameters comprising a first threshold value (A), a second threshold value (B), and a configurable observation period (T) for the data transmission;
   transmit at least one of a secondary cell addition command to add the one or more secondary cells (500b and/or 500c) for the data transmission and a secondary cell measurement configuration to the UE (400) for the secondary cell addition, based on the one or more configured network parameters;
   perform at least one of a secondary cell activation and a secondary cell deactivation for the one or more added secondary cells (500b and/or 500c) based on the first threshold value (A); and
   transmit, after the secondary cell deactivation, at least one of a secondary cell removal command to eliminate the one or more added secondary cells (500b and/or 500c)and a removal of secondary cell measurement configuration for the secondary cell addition, based on the one or more configured network parameters.

The various actions, acts, blocks, steps, or the like in the sequence flow diagrams may be performed in the order presented, in a different order, or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device or a combination of hardware devices and software modules. While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. A method comprising:
establishing, by a primary cell of a base station, a connection with a User Equipment (UE) for data transmission, wherein the base station comprises the primary cell and one or more secondary cells;
configuring, at the primary cell, one or more network parameters comprising a first threshold value, a second threshold value, and a configurable observation period for the data transmission;
transmitting, by the primary cell, at least one of a secondary cell addition command to add the one or more secondary cells for the data transmission and a secondary cell measurement configuration to the UE for the secondary cell addition,, based on the one or more configured network parameters;
performing, by the primary cell, at least one of a secondary cell activation and a secondary cell deactivation for the one or more added secondary cells based on the first threshold value; and
transmitting, after the secondary cell deactivation, by the primary cell, at least one of a secondary cell removal command to eliminate the one or more added secondary cells and a removal of secondary cell measurement configuration for the secondary cell addition, based on the one or more configured network parameters.

2. The method according to claim 1, wherein transmitting at least one of the secondary cell addition command to add the one or more secondary cells for the data transmission and the secondary cell measurement configuration to the UE for the purpose of secondary cell addition comprises:
continuously monitoring a Radio Link Control (RLC) queue size associated with the data transmission between the UE and the primary cell;
determining whether the RLC queue size remains above the second threshold value throughout the configurable observation period and a type of the secondary cell;
performing at least one of:
transmitting measurement configuration information in response to determining that the RLC queue size remains above the second threshold value throughout the configurable observation period,
wherein the measurement configuration information is transmitted to the UE to add the one or more secondary cells for the data transmission upon UE reporting the measurement, when the one or more secondary cells are classified as a second type of secondary cell; or
directly adding the one or more secondary cells configuration in response to determining that the RLC queue size remains above the second threshold value throughout the configurable observation period,
wherein the one or more secondary cells configuration is added directly in the UE for the data transmission when the one or more secondary cells are classified as a first type of secondary cell.

3. The method according to claim 1, wherein performing the secondary cell activation for the one or more added secondary cells based on the first threshold value comprises:
determining whether a Radio Link Control (RLC) queue size remains above the first threshold value; and
transmitting a secondary cell activation command to the UE in response to determining that the RLC queue size remains above the first threshold value,
wherein the secondary cell activation command indicates that the UE utilizes one or more resources associated with each cell of the base station for the data transmission.

4. The method according to claim 1, wherein performing the secondary cell deactivation for the one or more added secondary cells based on the first threshold value comprises:
determining whether a Radio Link Control (RLC) queue size does not remain above the first threshold value; and
transmitting a secondary cell deactivation command to the UE in response to determining that the RLC queue size does not remain above the first threshold value,
wherein the secondary cell deactivation command indicates that the UE utilizes one or more resources associated solely with the primary cell of the base station for the data transmission.

5. The method according to claim 1, wherein transmitting the secondary cell removal command, to eliminate the one or more added secondary cells, based on the one or more configured network parameters comprises:
continuously monitoring a Radio Link Control (RLC) queue size associated with the data transmission between the UE and the primary cell;
determining whether the RLC queue size remains below the second threshold value throughout the configurable observation period; and
removing the one or more secondary cells configuration in response to determining that the RLC queue size does not remain above the second threshold value throughout the configurable observation period,
wherein the one or more secondary cells configuration is removed directly in the UE for the data transmission.

6. The method according to claim 1, wherein transmitting the removal of measurement configuration for the secondary cell addition, based on the one or more configured network parameters comprises:
continuously monitoring a Radio Link Control (RLC) queue size associated with the data transmission between the UE and the primary cell;
determining whether the RLC queue size remains below the second threshold value throughout the configurable observation period; and
removing the one or more secondary cells measurement configuration in response to determining that the RLC queue size does not remain above the second threshold value throughout the configurable observation period,
wherein the one or more secondary cells measurement configuration is removed in the UE where the one or more secondary cells are classified as a second type of secondary cell.

7. The method according to claim 1, comprising:
wherein the first threshold value represents a size of a Radio Link Control (RLC) queue required to activate or deactivate the one or more secondary cells;
wherein the second threshold value is defined as a configurable percentage of the first threshold value,
wherein the second threshold value is utilized to add or remove the one or more secondary cells; and
wherein the second threshold value is utilized to configure or remove the one or more secondary cell measurement configuration for the one or more secondary cells classified as a second type of secondary cell.

8. The method according to claim 1, wherein the one or more secondary cells are classified into either a first type of secondary cell or a second type of secondary cell.

9. The method according to claim 1, further comprising:
for a second type of secondary cell, in response to transmitting configuration information to remove the measurement configuration or not to configure measurement configuration to add the one or more secondary cells, by the primary cell, a measurement gap configuration is avoided;
for a first type of secondary cell, avoid configuring secondary cells addition command directly, by the primary cell, for better radio utilization at the base station and energy saving at the UE; and
for the first type of secondary cell or the second type of secondary cell, removing the one or more added secondary cells configuration, by the primary cell, for better radio utilization at the base station and energy saving at the UE.

10. The method according to claim 1, wherein the UE supports a carrier aggregation and a carrier aggregation feature is enabled at the base station for the data transmission.

11. An apparatus, the apparatus is configured to:
establish a connection with a User Equipment (UE) for data transmission, wherein the base station comprises the primary cell and one or more secondary cells;
configure one or more network parameters comprising a first threshold value, a second threshold value, and a configurable observation period for the data transmission;
transmit at least one of a secondary cell addition command to add the one or more secondary cells for the data transmission and a secondary cell measurement configuration to the UE for the secondary cell addition, based on the one or more configured network parameters;
perform at least one of a secondary cell activation and a secondary cell deactivation for the one or more added secondary cells based on the first threshold value; and
transmit, after the secondary cell deactivation, at least one of a secondary cell removal command to eliminate the one or more added secondary cells and a removal of secondary cell measurement configuration for the secondary cell addition, based on the one or more configured network parameters.

12. The apparatus according to claim 11, wherein to transmit the at least one of the secondary cell addition command to add the one or more secondary cells and the secondary cell measurement configuration to the UE for the secondary cell addition, the apparatus is configured to:
continuously monitor a Radio Link Control (RLC) queue size associated with the data transmission between the UE and the primary cell;
determine whether the RLC queue size remains above the second threshold value throughout the configurable observation period and a type of the secondary cell;
perform at least one of:
transmit measurement configuration information in response to determining that the RLC queue size remains above the second threshold value throughout the configurable observation period,
wherein the measurement configuration information is transmitted to the UE to add the one or more secondary cells for the data transmission upon UE reporting the measurement, when the one or more secondary cells are classified as a second type of secondary cell; or
directly add the one or more secondary cells configuration in response to determining that the RLC queue size remains above the second threshold value throughout the configurable observation period,
wherein the one or more secondary cells configuration is added directly in the UE for the data transmission when the one or more secondary cells are classified as a first type of secondary cell.

13. The apparatus according to claim 11, wherein to perform the secondary cell activation for the one or more added secondary cells based on the first threshold value, the apparatus is configured to:
determine whether a Radio Link Control (RLC) queue size remains above the first threshold value; and
transmit a secondary cell activation command to the UE in response to determining that the RLC queue size remains above the first threshold value,
wherein the secondary cell activation command indicates that the UE utilizes one or more resources associated with each cell of the base station for the data transmission.

14. The apparatus according to claim 11, wherein to perform the secondary cell deactivation for the one or more added secondary cells based on the first threshold value, the apparatus is configured to:
determine whether a Radio Link Control (RLC) queue size does not remain above the first threshold value; and
transmit a secondary cell deactivation command to the UE in response to determining that the RLC queue size does not remain above the first threshold value,
wherein the secondary cell deactivation command indicates that the UE utilizes one or more resources associated solely with the primary cell of the base station for the data transmission.

15. The apparatus according to claim 11, wherein to transmit the secondary cell removal command to eliminate the one or more added secondary cells, based on the one or more configured network parameters, the apparatus is configured to:
continuously monitor a Radio Link Control (RLC) queue size associated with the data transmission between the UE and the primary cell;
determine whether the RLC queue size remains below the second threshold value throughout the configurable observation period; and
remove the one or more secondary cells configuration in response to determining that the RLC queue size does not remain above the second threshold value throughout the configurable observation period,
wherein the one or more secondary cells configuration is removed directly in the UE for the data transmission.

16. The apparatus according to claim 11, wherein to transmit the removal of measurement configuration for the secondary cell addition, based on the one or more configured network parameters, the apparatus is configured to:
continuously monitor a Radio Link Control (RLC) queue size associated with the data transmission between the UE and the primary cell;
determine whether the RLC queue size remains below the second threshold value throughout the configurable observation period; and
remove the one or more secondary cells measurement configuration in response to determining that the RLC queue size does not remain above the second threshold value throughout the configurable observation period,
wherein the one or more secondary cells measurement configuration is removed in the UE where the one or more secondary cells are classified as a second type of secondary cell.

17. The apparatus according to claim 11, comprising:
wherein the first threshold value represents a size of a Radio Link Control (RLC) queue required to activate or deactivate the one or more secondary cells;
wherein the second threshold value is defined as a configurable percentage of the first threshold value,
wherein the second threshold value is utilized to add or remove the one or more secondary cells; and
wherein the second threshold value is utilized to configure or remove the one or more secondary cell measurement configurations for the one or more secondary cells classified as a second type of secondary cell.

18. The apparatus according to claim 11, wherein the one or more secondary cells are classified into either a first type of secondary cell or a second type of secondary cell.

19. The apparatus according to claim 11, further comprising:
for a second type of secondary cell, in response to transmitting configuration information to remove the measurement configuration or not to configure measurement configuration to add the one or more secondary cells, by the primary cell, a measurement gap configuration is avoided;
for a first type of secondary cell, avoid configuring secondary cells addition command directly, by the primary cell, for a better radio utilization at the base station and energy saving at the UE; and
for the first type of secondary cell or the second type of secondary cell, removing the one or more added secondary cells configuration, by the primary cell, for a better radio utilization at the base station and energy saving at the UE.

20. A non-transitory computer-readable medium storing instructions, the instructions comprising: one or more instructions that, when executed by an apparatus, the s apparatus comprising one or more processors, cause the one or more processors to:
establish a connection with a User Equipment (UE) for data transmission, wherein the base station comprises the primary cell and one or more secondary cells;
configure one or more network parameters comprising a first threshold value, a second threshold value, and a configurable observation period for the data transmission;
transmit at least one of a secondary cell addition command to add the one or more secondary cells for the data transmission and a secondary cell measurement configuration to the UE for the secondary cell addition, based on the one or more configured network parameters;
perform at least one of a secondary cell activation and a secondary cell deactivation for the one or more added secondary cells based on the first threshold value; and
transmit, after the secondary cell deactivation, at least one of a secondary cell removal command to eliminate the one or more added secondary cells and a removal of secondary cell measurement configuration for the secondary cell addition, based on the one or more configured network parameters.
